(19) United States
(12) Patent Application Publication
(10) Pub. No.: US 2016/0321427 A1
(43) Pub. Date: Nov. 3, 2016

(54) Patient-Specific Therapy Planning Support Using Patient Matching

(71) Applicant: Siemens Medical Solutions USA, Inc., Malvem, PA (US)

(72) Inventors: Luca Bogoni, Philadelphia, PA (US); Marcos Salganicoff, Bala Cynwyd, PA (US); Matthias Wolf, Coatesville, PA (US); Xiang Sean Zhou, Exton, PA (US); Yiqiang Zhan, Berwyn, PA (US)

(21) Appl. No.: 15/089,725

(22) Filed: Apr. 4, 2016

Related U.S. Application Data
(60) Provisional application No. 62/153,625, filed on Apr. 28, 2015.

(51) Int. Cl. G06F 19/00; G06N 99/00

(52) U.S. Cl. CPC G06F 19/3443; G06F 19/321; G06F 19/324; G06N 99/005

(57) ABSTRACT

A framework for supporting therapy planning is described herein. In accordance with one aspect, patient-specific characteristics are extracted from medical data associated with a given patient. The framework may then search a database for one or more other patients associated with personal characteristics that are similar to the patient-specific characteristics. Information associated with the one or more other patients may be presented to support therapy planning or diagnosis.

### CROSS-REFERENCE TO RELATED APPLICATION

The present application claims the benefit of U.S. provisional application No. 62/153,625 filed Apr. 28, 2015, the entire contents of which are herein incorporated by reference.

### TECHNICAL FIELD

The present disclosure generally relates to medical data processing, and more particularly to patient-specific therapy planning support using patient matching.

### BACKGROUND

The field of medical imaging has seen significant advances since the time X-Rays were first used to determine anatomical abnormalities. Medical imaging hardware has progressed in the form of newer machines such as Magnetic Resonance Imaging (MRI) scanners, Computed Axial Tomography (CAT) scanners, etc. Because of the large amount of image data generated by such modern medical scanners, there has been and remains a need for developing image processing techniques that can automate some or all of the processes to determine the presence of anatomical abnormalities in scanned medical images.

Digital medical images are constructed using raw image data obtained from a scanner, for example, a CAT scanner, MRI, etc. Digital medical images are typically either a two-dimensional (“2D”) image made of pixel elements or a three-dimensional (“3D”) image made of volume elements (“voxels”). Such 2D or 3D images are processed using medical image recognition techniques to determine the presence of anatomical structures such as cysts, tumors, polyps, etc. Given the amount of image data generated by any given image scan, it is preferable that an automatic technique should point out anatomical features in the selected regions of an image to a doctor for further diagnosis of any disease or condition.

Computer-aided detection (CAD) techniques are typically used to assist physicians in the interpretation of medical images. Although CAD systems have shown promising results in lesion detection, state-of-the-art algorithms often perform as black boxes. In other words, such CAD systems only report suspicious lesions without giving the reasons behind diagnosis. The lack of diagnostic reasons sometimes decreases clinicians' confidence in CAD systems.

Besides accurate diagnosis, a physician needs to find the optimal therapy or treatment for the patients. This process is typically driven by medical knowledge, experience and intuition. However, it is often very difficult, or impossible, for any physician to compare treatment options on a larger set of patients. Additionally, a given institution may not offer all treatment options.

### SUMMARY

Described herein are systems and methods for supporting therapy planning or diagnosis. In accordance with one aspect, patient-specific characteristics are extracted from medical data associated with a given patient. The framework then searches a database for one or more patients associated with personal characteristics that are similar to the patient-specific characteristics. Information associated with the one or more patients may be presented to support therapy planning or diagnosis.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings.

FIG. 1 is a block diagram illustrating an exemplary system;

FIG. 2 shows an exemplary implementation of a system for supporting therapy planning or diagnosis;

FIG. 3 shows an exemplary method of supporting therapy planning or diagnosis; and

FIG. 4 illustrates an exemplary matching process.

### DETAILED DESCRIPTION

In the following description, numerous specific details are set forth such as examples of specific components, devices, methods, etc., in order to provide a thorough understanding of implementations of the present framework. It will be apparent, however, to one skilled in the art that these specific details need not be employed to practice implementations of the present framework. In other instances, well-known materials or methods have not been described in detail in order to avoid unnecessarily obscuring implementations of the present framework. While the present framework is susceptible to various modifications and alternative forms, specific embodiments thereof are shown by way of example in the drawings and will herein be described in detail. It should be understood, however, that there is no intent to limit the invention to the particular forms disclosed, but on the contrary, the intention is to cover all modifications, equivalents, and alternatives falling within the spirit and scope of the invention. Furthermore, for ease of understanding, certain method steps are delineated as separate steps; however, these separately delineated steps should not be construed as necessarily order dependent in their performance.

The term “x-ray image” as used herein may mean a visible x-ray image (e.g., displayed on a video screen) or a digital representation of an x-ray image (e.g., a file corresponding to the pixel output of an x-ray detector). The term “in-treatment x-ray image” as used herein may refer to images captured at any point in time during a treatment delivery phase of an interventional or therapeutic procedure, which may include times when the radiation source is either on or off. From time to time, for convenience of description, CT imaging data (e.g., cone-beam CT imaging data) may be used herein as an exemplary imaging modality. It will be appreciated, however, that data from any type of imaging modality including but not limited to x-ray radiographs, MRI, PET (positron emission tomography), PET-CT, SPECT, SPECT-CT, MR-PET, 3D ultrasound images or the like may also be used in various implementations.

Unless stated otherwise as apparent from the following discussion, it will be appreciated that terms such as “segmenting,” “generating,” “registering,” “determining,” “aligning,” “positioning,” “processing,” “computing,” “selecting,” “estimating,” “detecting,” “tracking” or the like may refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices. Embodiments of the methods described herein may be implemented using computer software. If written in a programming language conforming to a recognized standard, sequences of instructions designed to implement the methods can be compiled for execution on a variety of hardware platforms and for interface to a variety of operating systems. In addition, implementations of the present framework are not described with reference to any particular programming language. It will be appreciated that a variety of programming languages may be used.

As used herein, the term “image” refers to multi-dimensional data composed of discrete image elements (e.g., pixels for 2D images and voxels for 3D images). The image may be, for example, a medical image of a subject collected by computer tomography, magnetic resonance imaging, ultrasound, or any other medical imaging system known to one of skill in the art. The image may also be provided from non-medical contexts, such as, for example, remote sensing systems, electron microscopy, etc. Although an image can be thought of as a function from R³ to R, or a mapping to R³, the present methods are not limited to such images, and can be applied to images of any dimension, e.g., a 2D picture or a 3D volume. For a 2- or 3-dimensional image, the domain of the image is typically a 2- or 3Dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

The terms “pixels” for picture elements, conventionally used with respect to 2D imaging and image display, and “voxels” for volume image elements, often used with respect to 3D imaging, can be used interchangeably. It should be noted that the 3D volume image is itself synthesized from image data obtained as pixels on a 2D sensor array and displays as a 2D image from some angle of view. Thus, 2D image processing and image analysis techniques can be applied to the 3D volume image data. In the description that follows, techniques described as operating upon pixels may alternately be described as operating upon the 3D voxel data that is stored and represented in the form of 2D pixel data for display. In the same way, techniques that operate upon voxel data can also be described as operating upon pixels. In the following description, the variable x is used to indicate a subject image element at a particular spatial location or, alternately considered, a subject pixel. The terms “subject pixel” or “subject voxel” are used to indicate a particular image element as it is operated upon using techniques described herein.

A framework for supporting therapy planning or diagnosis is described herein. In accordance with one aspect, the framework extracts patient-specific characteristics from medical data associated with any given patient. The framework identifies other patients with similar characteristics from a large dataset to provide additional information to enable the physician to provide the most optimal therapy plan or diagnosis. The information presented (or displayed) to the physician is patient-specific, as it personalizes the characteristics of the patient's condition in the context of a sub-population that best matches the patient. These and other advantages and features will be described in more details herein.

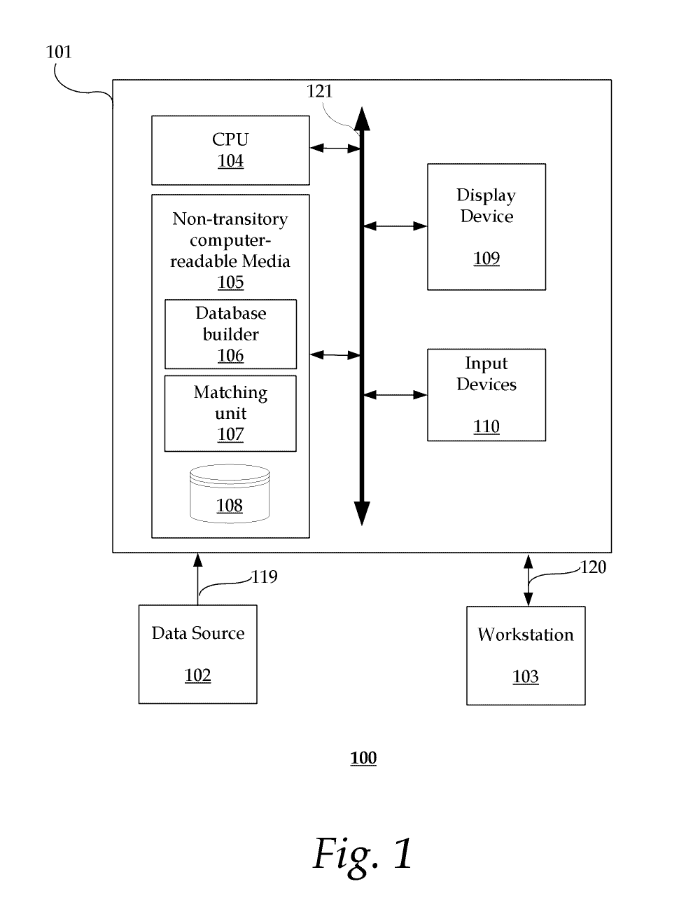

FIG. 1 is a block diagram illustrating an exemplary system 100. The system 100 includes a computer system 101 for implementing the framework as described herein. In some implementations, computer system 101 operates as a standalone device. In other implementations, computer system 101 may be connected (e.g., using a network) to other machines, such as data source 102 and workstation 103. In a networked deployment, computer system 101 may operate in the capacity of a server (e.g., thin-client server, such as syngo.via® by Siemens Healthcare), a cloud computing platform, a client user machine in server-client user network environment, or as a peer machine in a peer-to-peer (or distributed) network environment.

In one implementation, computer system 101 comprises a processor or central processing unit (CPU) 104 coupled to one or more non-transitory computer-readable media 105 (e.g., computer storage or memory), display device 109 (e.g., monitor) and various input devices 110 (e.g., mouse or keyboard) via an input-output interface 121. Computer system 101 may further include support circuits such as a cache, a power supply, clock circuits and a communications bus. Various other peripheral devices, such as additional data storage devices and printing devices, may also be connected to the computer system 101.

The present technology may be implemented in various forms of hardware, software, firmware, special purpose processors, or a combination thereof, either as part of the microinstruction code or as part of an application program or software product, or a combination thereof, which is executed via the operating system. In one implementation, the techniques described herein are implemented as computer-readable program code tangibly embodied in non-transitory computer-readable media 105. In particular, the present techniques may be implemented by a database builder 106 and a matching unit 107. Non-transitory computer-readable media 105 may include random access memory (RAM), read-only memory (ROM), magnetic floppy disk, flash memory, and other types of memories, or a combination thereof. The computer-readable program code is executed by CPU 104 to process medical data retrieved from, for example, data source 102. As such, the computer system 101 is a general-purpose computer system that becomes a specific purpose computer system when executing the computer-readable program code. The computer-readable program code is not intended to be limited to any particular programming language and implementation thereof. It will be appreciated that a variety of programming languages and coding thereof may be used to implement the teachings of the disclosure contained herein.

The same or different computer-readable media 105 may be used for storing a database (or dataset) 108. Such data may also be stored in external storage or other memories. The external storage may be implemented using a database management system (DBMS) managed by the CPU 104 and residing on a memory, such as a hard disk, RAM, or removable media. The external storage may be implemented on one or more additional computer systems. For example, the external storage may include a data warehouse system residing on a separate computer system, a picture archiving and communication system (PACS), or any other now known or later developed hospital, medical institution, medical office, testing facility, pharmacy or other medical patient record storage system.

The data source 102 provides medical data 119 associated with different patients. Such medical data may include radiology reports, image data, laboratory test results, prior examination reports, diagnostic data, treatment plans, treatment outcomes, and other patient-specific information. Such medical data 119 may be processed by database builder 106 and stored in database 108. Data source 102 may be a computer, memory device, a radiology scanner (e.g., X-ray or a CT scanner) and/or appropriate peripherals (e.g., keyboard and display device) for acquiring, inputting, collecting, generating and/or storing such medical data. In some implementations, data source 102 further includes a computer-aided detection (CAD) system for identifying lesions or other abnormalities in medical image data.

The workstation 103 may include a computer and appropriate peripherals, such as a keyboard and display device, and can be operated in conjunction with the entire system 100. For example, the workstation 103 may communicate with the data source 102 so that the medical data collected by the data source 102 can be rendered at the workstation 103 and viewed on a display device. The workstation 103 may also provide a medical data 120 of a current or given patient. The workstation 103 may include a graphical user interface to receive user input via an input device (e.g., keyboard, mouse, touch screen voice or video recognition interface, etc.) to input the current medical data 120. The workstation 103 may communicate directly with the computer system 101 to, for example, invoke the matching unit 107 to find patients with similar characteristics that match the current medical data 120. Information associated with similar patients may be returned to the workstation 103 for display to the user (e.g., physician).

It is to be further understood that, because some of the constituent system components and method steps depicted in the accompanying figures can be implemented in software, the actual connections between the systems components (or the process steps) may differ depending upon the manner in which the present framework is programmed. Given the teachings provided herein, one of ordinary skill in the related art will be able to contemplate these and similar implementations or configurations of the present framework.

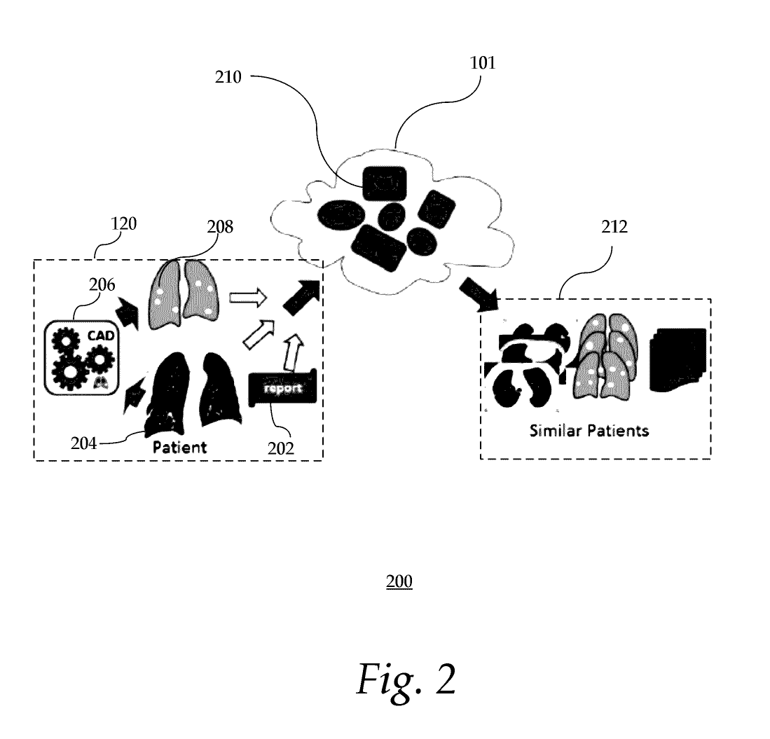

FIG. 2 shows an exemplary implementation of a system 200 for supporting therapy planning or diagnosis. Medical data 120 associated with a current patient with lung cancer is provided to system 101 (e.g., cloud computing platform) to find a best match. Such medical data 120 may be provided by, for example, workstation 103. Medical data 120 may include a medical report 202, image data (or images) 204 of the patient's lungs and associated lesion-specific data. A CAD system 206 may be employed to detect nodular lesions 208 in the image data 204 and generate the lesion-specific data. Image data (current and possibly priors) 204, lesion-specific data and medical report(s) 202 may be sent to the system 101 to be matched with characteristics 210 (e.g., C1, C2, Ck) of a set of patients. Information 212 of other patients with similar characteristics is returned and displayed to the physician, so that the best therapy may be chosen. The returned information 212 may include image data, CAD detection results, therapy outcomes and/or medical reports associated with the best matching patients.

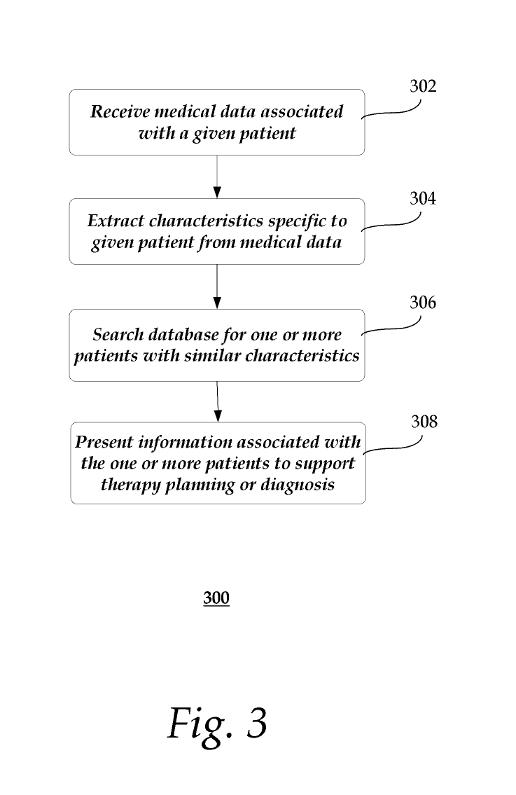

FIG. 3 shows an exemplary method 300 of supporting therapy planning or diagnosis by a computer system. It should be understood that the steps of the method 300 may be performed in the order shown or a different order. Additional, different, or fewer steps may also be provided. Further, the method 300 may be implemented with the system 101 of FIG. 1, a different system, or a combination thereof

At 302, matching unit 107 receives medical data associated with a given patient. The given patient may be, for example, a patient currently undergoing examination, evaluation or therapy (or treatment) by a physician. The medical data of the given patient may be provided via, for example, workstation 103. The medical data may include image data of one or more regions of interest (e.g., lungs, liver, brain), one or more prior medical reports, abnormality identification data, and/or any other available information.

The image data may be acquired using techniques such as magnetic resonance (MR) imaging, computed tomography (CT), helical CT, X-ray, angiography, positron emission tomography (PET), fluoroscopy, ultrasound, single photon emission computed tomography (SPECT), or a combination thereof. The region of interest may be any area or volume identified for investigation or examination, such as at least a portion of a patient's or subject's lung, liver, brain, heart, spine, vertebra, blood vessel, aorta, and so forth.

The medical report may include a description of the clinical condition (e.g., medical history and care) and the demographic characteristics (e.g., gender, age, race, etc.) of the patient over time. The medical report may include a description of the clinical condition of the patient as observed by healthcare professionals (e.g., physician) during physical examination, “notes” entered over time by healthcare professionals, records of observations and administration of drugs and therapies, orders for the administration of drugs and therapies, laboratory test results, x-rays, reports, etc. The medical report may also describe an account of the symptoms as experienced by the patient (i.e., medical history).

Abnormality identification data describes an abnormality (e.g., lesion, polyp, disease, tumor) detected based on the image data (e.g., radiology report). Such abnormality identification data may be generated manually, semi-automatically or automatically by performing a computer-aided detection (CAD) technique (e.g., lung CAD, pulmonary embolism CAD, colon CAD, etc.). The CAD technique may be locally performed by computer system 101 or remotely performed by another computer system. Other techniques may also be used to generate the abnormality identification data. The abnormality identification data may include, but is not limited to, the number of abnormalities, size, location and/or burden of each abnormality, tumor stage, characterization of change over time, and so forth.

At 304, matching unit 107 extracts patient-specific characteristics from the medical data. Patient-specific characteristics may include organ-specific characteristics, abnormality-specific characteristics, clinical conditions and demographic characteristics associated with the given patient. Organ-specific characteristics describe findings with respect to the region of interest, such as the lung parenchyma, brain tissue or liver tissue. Exemplary findings may include, for example, an enlarged heart, enlarged aorta, volume of the liver, and so forth. Abnormality-specific characteristics may be extracted from the abnormality identification data generated by, for example, an automatic lesion detection system or CAD system. Additional information about the abnormality, such as the shape, number of occurrences, texture, location in the body or an organ, may also be automatically extracted from one or more medical reports or other supporting examination data (e.g. medical image data).

At 306, matching unit 107 searches the database 108 for one or more other patients with personal characteristics that are similar to the patient-specific characteristics including abnormality-specific characteristics. For example, matching unit 107 may find lung cancer patients with lesion characteristics, lung parenchyma characteristics, demographic characteristics and clinical conditions that are most similar to the patient-specific characteristics of the given patient.

The database 108 may be previously generated by database builder 106 based on a large set of medical data associated with a population of patients. Database builder 106 may generate the database 108 by analyzing (e.g., clustering) the medical records based on various meaningful characteristics. In some implementations, the database is built by parsing textual data of medical records and/or performing automated detection tasks on signal data (e.g., image data, electrocardiograms). The characteristics may be extracted from image data (single or multiple studies), medical reports, abnormality identification data, and/or any other available information. Examples of such characteristics include, but are not limited to, clinical conditions, demographic characteristics, as well as organ-specific characteristics and abnormality-specific characteristics. Additionally, database builder 106 may process the large set of medical records to determine trends across the population of patients.

Abnormality-specific characteristics may be generated manually, semi-automatically or automatically by a CAD system (e.g., lung CAD, pulmonary embolism CAD, colon CAD, etc.). Techniques other than CAD may also be used to generate such abnormality-specific characteristics. Abnormality-specific characteristics include, but are not limited to, the number of abnormalities, morphology of the abnormality (e.g., lesion), size and/or location of the abnormality (e.g., which organ or within organ), burden (e.g., severity, with respect to the individual lesion as well as other lesions present, as well as the quantity of lesions that are present), overall condition of the patient, characterization of change over time, and so forth. In addition, a single patient in the database 108 may be associated with comorbidities (i.e., simultaneous presence of multiple chronic diseases or abnormalities). As such, characteristics of more than one type of abnormality may be extracted from a single patient's medical record.

A machine learning algorithm may be used to train a classifier to look for the patients with the highest similarities with respect to the given patient. Similarity may be defined by how the original training data are clustered and provided to the machine learning algorithm. Similarity may be based on the visual appearance of a nodule, the total burden of pulmonary emboli, the size and distribution of tumors, etc. In some implementations, the machine learning algorithm is a deep learning algorithm based on, for example, deep neural networks, convolutional deep neural networks, deep belief networks and recurrent neural networks.

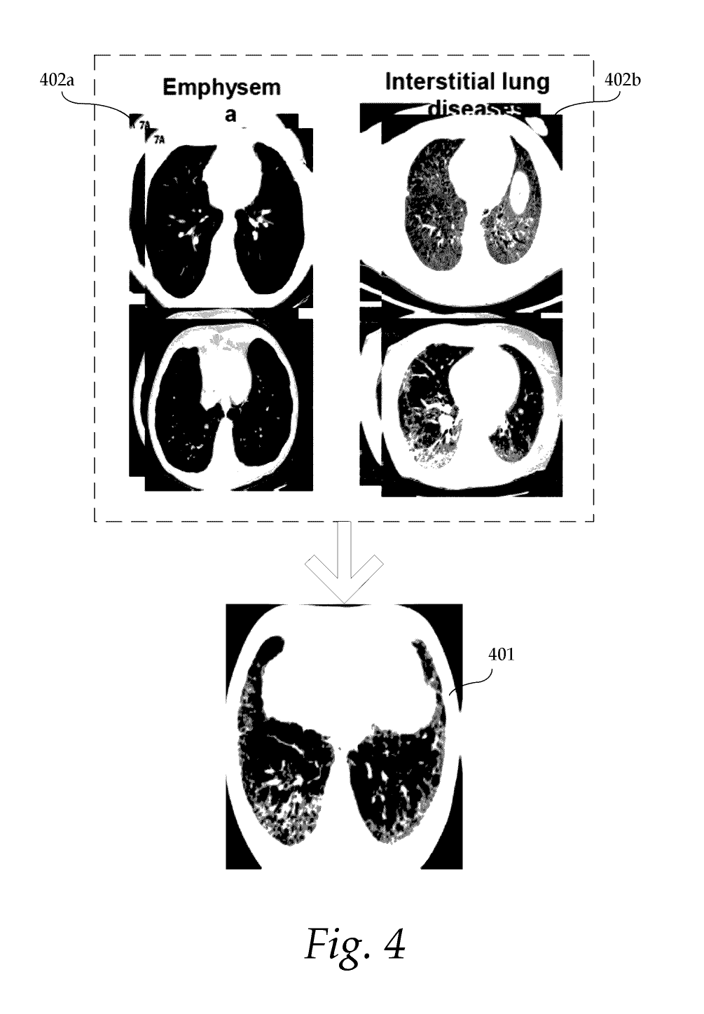

FIG. 4 illustrates an exemplary matching process. Given a radiology image 401 of the patient's lungs, the matching unit 107 searches the set of medical records 402a-b in the database 108 for patients with similar lung parenchyma characteristics. As shown, the database 108 includes medical records 402a-b with lung images of patients with emphysema and interstitial lung disease. The matching unit 107 may automatically return a set of lung images that have similar lung parenchyma characteristics. By matching the automatically-detected lesions in the radiology image 401 with the most similar ones in the database 108, existing labels, report information and diagnostic reasons from those matching medical records may be used to validate the diagnosis or automatically-detected lesions in the radiology image 401, plan the treatment by selecting the most promising therapy based on the outcome for the most similar matches, or predict the outcome.

At 308, matching unit 107 presents information associated with the matching similar patients to support therapy planning or diagnosis. The information is advantageously patient-specific, as it personalizes the characteristics of the given patient's condition in the context of the condition from the sub-population of other similar patients that best matches the patient. In some implementations, for each of the matching patients, the diagnosis, selected therapy (or treatment) option, outcome of the selected therapy, predictions, image data as well as other information related to the abnormality are extracted from the associated medical records in the database 108 and presented (e.g., displayed) to the physician (or other user). As the physician explores alternative therapies, the risk, toxicity or outcome of a given therapy may be predicted based on such information.

The information may also serve as additional evidence to support the diagnosis or abnormality identification data generated by the CAD system and thereby improve the clinician's confidence in the CAD system. The information may be used to validate the detection results of the CAD system and improve its accuracy. For example, the abnormality identification data associated with the given patient may be compared to the abnormality identification data associated with the other similar patients to determine if they are substantially consistent. Such evidentiary information is easily retrieved by the present framework without any need for computationally expensive segmentation techniques. Additionally, the framework can be easily scaled up by collecting more medical records for the database 108.

While the present framework has been described in detail with reference to exemplary embodiments, those skilled in the art will appreciate that various modifications and substitutions can be made thereto without departing from the spirit and scope of the invention as set forth in the appended claims. For example, elements and/or features of different exemplary embodiments may be combined with each other and/or substituted for each other within the scope of this disclosure and appended claims.

What is claimed is:

1. A non-transitory computer readable medium embodying a program of instructions executable by machine to perform operations, the operations comprising:
receiving medical data including image data of a region of interest associated with a given patient;
extracting patient-specific characteristics from the medical data, wherein the patient-specific characteristics are extracted in part from abnormality identification data that is automatically generated from the image data;
searching a database for one or more other patients associated with personal characteristics that are similar to the patient-specific characteristics, wherein the personal characteristics include abnormality-specific characteristics; and
presenting information associated with the one or more other patients to validate the abnormality identification data.

2. The non-transitory computer readable medium of claim 1, wherein the searching the database for the one or more other patients comprises applying a machine learning algorithm to train a classifier and applying the trained classifier to look for the one or more other patients.

3. A system comprising:
a non-transitory memory device for storing computer readable program code; and
a processor in communication with the memory device, the processor being operative with the computer readable program code to perform operations including
receiving medical data associated with a given patient,
extracting patient-specific characteristics from the medical data,
searching a database for one or more other patients associated with personal characteristics that are similar to the patient-specific characteristics, and
presenting information associated with the one or more other patients to support therapy planning or diagnosis.

4. The system of claim 3 wherein the medical data comprises image data of one or more regions of interest, one or more medical reports and abnormality identification data.

5. The system of claim 4 wherein the image data is acquired using techniques such as magnetic resonance (MR) imaging, computed tomography (CT), helical CT, X-ray, angiography, positron emission tomography (PET), fluoroscopy, ultrasound, single photon emission computed tomography (SPECT), or a combination thereof

6. The system of claim 4 wherein the one or more regions of interest comprises at least a portion of a lung and the abnormality identification data comprises lesion-specific data.

7. The system of claim 4 wherein the one or more medical reports comprises a description of a clinical condition and demographic characteristics.

8. The system of claim 3 wherein the processor is operative with the computer readable program code to automatically generate the abnormality identification data by performing a computer-aided detection technique.

9. The system of claim 8 wherein the abnormality identification data comprises a number of abnormalities, size, location or burden of at least one of the abnormalities, or a combination thereof.

10. The system of claim 3 wherein the processor is operative with the computer readable program code to extract the patient-specific characteristics by extracting organ-specific characteristics, abnormality-specific characteristics or a combination thereof.

11. The system of claim 3 wherein the processor is operative with the computer readable program code to extract the abnormality-specific characteristics from one or more medical reports and abnormality identification data generated by a computer-aided detection system.

12. The system of claim 3 wherein the processor is operative with the computer readable program code to search the database for the one or more other patients by applying a machine learning algorithm to train a classifier and applying the trained classifier to look for the one or more other patients.

13. The system of claim 12 wherein the processor is operative with the computer readable program code to search the database for the one or more other patients by applying a deep learning algorithm to train the classifier.

14. The system of claim 13 wherein the processor is operative with the computer readable program code to search the database for the one or more other patients by applying deep neural networks, convolutional deep neural networks, deep belief networks or recurrent neural networks to train the classifier.

15. The system of claim 3 wherein the processor is operative with the computer readable program code to generate the database by clustering, according to meaningful personal characteristics, medical data associated with a population of patients.

16. The system of claim 15 wherein the processor is operative with the computer readable program code to extract the personal characteristics from the medical data.

17. The system of claim 16 wherein the personal characteristics comprise at least one clinical condition, at least one demographic characteristic, at least one organ-specific characteristic or at least one abnormality-specific characteristic.

18. The system of claim 17 wherein the at least one abnormality-specific characteristic comprises characteristics of more than one type of abnormality or overall condition associated with a single patient.

19. The system of claim 3 wherein the processor is operative with the computer readable program code to present information associated with the one or more other patients by displaying a diagnosis, selected therapy option, outcome of the selected therapy option, or a combination thereof.

20. A method, comprising:
receiving medical data associated with a given patient;
extracting patient-specific characteristics from the medical data;
searching a database for one or more other patients associated with personal characteristics that are similar to the patient-specific characteristics; and
presenting information associated with the one or more other patients to support therapy planning or diagnosis.
